(19) United States
(12) Patent Application Publication
(10) Pub. No.: US 2013/0291965 A1
(43) Pub. Date: Nov. 7, 2013

(54) CHECK VALVE

(71) Applicant: Keck Graduate Institute Of Applied Life Sciences, Claremont, CA (US)

(72) Inventor: Anna Hickerson, Altadena, CA (US)

(21) Appl. No.: 13/859,680

(22) Filed: Apr. 9, 2013

Related U.S. Application Data
(60) Provisional application No. 61/621,989, filed on Apr. 9, 2012.
(60) Provisional application No. 61/800,749, filed on Mar. 15, 2013.

(51) Int. Cl. F16K 15/00

(52) U.S. Cl. CPC F16K 15/00
USPC 137/511

(57) ABSTRACT

A valve has a generally hollow core with one open end and one closed end, and at least one side port in a sidewall of the core. The valve also includes a sleeve that fits over the core and covers the side port(s). The cracking pressure of the valve is tunable by varying the parameters of the sleeve.

### CROSS-REFERENCE TO RELATED APPLICATION(S)

This application claims priority to and the benefit of U.S. Provisional Application Ser. No. 61/621,989 filed on Apr. 9, 2012 and titled CHECK VALVE, and U.S. Provisional Application Ser. No. 61/800,749 filed on Mar. 15, 2013 and titled DISPOSABLE MINIATURE CHECK VALVE DESIGN SUITABLE FOR SCALABLE MANUFACTURING, the entire contents of both of which are incorporated herein by reference.

### STATEMENT REGARDING FEDERALLY SPONSORED RESEARCH OR DEVELOPMENT

This invention was made with government support under Grant Nos. R01A1076247 and RO1AI090831 awarded by the National Institutes of Health. The government has certain rights in the invention.

### TECHNICAL FIELD

The disclosure is directed to valves, for example, check valves.

### BACKGROUND

The use of valves, in combination with other components, is fundamental to the control and manipulation of fluids. There exist a variety of solutions for passive and active valves, each with their own advantages and limitations. Many applications of passive valves, e.g. in medical devices and diagnostics, have a specific set of requirements that are difficult to meet with current valve technology. For example, valves used in medical diagnostics and devices must be compatible with certain biomaterials, such as enzymes and other reagents used in clinical diagnostic applications. Some existing stand-alone passive valves include ball-and-spring, duckbill, and umbrella valves. However, none of these currently available commercial options provide a suitable, cost-effective valve for use in certain applications, such as, for example, disposable medical devices. For example, the Lee Company (Westbrook, Conn.) produces a ball-and-spring valve that meets many of the physical requirements, but is cost prohibitive. In addition to other challenges, many of the remaining commercially available valve options have installation configurations that create dead volumes too large for typical diagnostic assays.

Also, valves made using microfabrication techniques (in contrast to stand-alone passive valves), such as photolithography, can be very small and often have negligible dead volumes. However, these techniques require the valve to be, at least in part, fabricated in the same way and at the same time as the system with which it is integrated, thereby greatly limiting the design options. Furthermore, linking macro and micro volumes in these microfabricated designs is a significant challenge, one that is essential for diagnostic systems that require large initial sample input volumes and much smaller volumes during final analysis.

### SUMMARY

In some embodiments of the present invention, a valve has a generally hollow core (10) with one open end and one closed end, and at least one side port (30) in a sidewall of the core. The valve also includes a sleeve (60) that fits over the core (10) and covers the side port(s) (30). The exterior of the core (10) is cylindrical in the area that functions as the valve, i.e., the area immediately surrounding the side port(s) on the core. However, other parts of the core, in particular the open end of the core, may have a different shape to facilitate press-fitting or other insertion methods of the valve into a device. The interior of the core (10) may be any shape so long as it remains generally hollow. For example, the inside of the core (10) may have a cross-section that is generally circular, trapezoidal, square or rectangular. However, the present invention is not limited to these shapes. In some embodiments, though, the core is generally cylindrical (i.e., the core exterior and interior have a generally circular cross-section). The cylindrical shape of the core according to these embodiments minimizes dead volume and simplifies the manufacturing process. The core is also elongated such that fluid entering the open end of the core travels along a length of the core before reaching the side port. Also, the core (10) may be made from any suitable rigid material, for example, metals or plastics. The side port (30) can be of any shape.

The sleeve (60) may be of any shape or size that is capable of sliding over the core and covering the side port(s) but generally is tubular, especially in the area that functions as the valve, i.e., the area immediately surrounding the side port(s) on the core. The inner diameter of the sleeve in the area that functions as the valve, in the relaxed state, is smaller than the outer diameter of the core in that same area. The sleeve is flexible in order to conform to the shape of the core. Also, the sleeve is made from any suitable elastomeric material capable of fitting over the cylindrical section of the core in a tight-fitting or snug manner.

In some embodiments, the valve consists essentially of the core and the sleeve, where the core has one open end and one closed end, and at least one side port in a side wall of the core, and the sleeve fits snugly over at least the portion of the core including the side port(s). As used herein, the term “consists essentially of” is intended to exclude any additional structural components taking part in the function of the valve, and indicates that the core and sleeve as described here are the main components of the valve and that the valve can function as a valve with no other components.

In some embodiments, the valve core (10) is generally cylindrical in shape and has an outer diameter (40) from about 1.0 to about 2.0 mm in size. The valve core also has an inner diameter (45). To fit over such a core, the sleeve may have an inner diameter (70) from about 0.70 mm to about 1.50 mm, and a sleeve wall thickness (80) from about 0.20 mm to about 0.50 mm. As can be appreciated, however, in order for the sleeve to fit tightly around the core, the inner diameter of the sleeve should be at least slightly smaller than the outer diameter of the core. Also, a ratio of the core outer diameter to the sleeve inner diameter may be about 1.05:1 to about 1.45:1, for example about 1.07:1 to about 1.45:1 or about 1.30:1 to about 1.45:1. In some embodiments, when the ratio of the core outer diameter (C_{Dout}) to the inner diameter of the sleeve (S_{Din}) is about 1.05 to 1.0 to about 1.29 to 1.0, the sleeve wall thickness may be in a range from about 0.20 to about 025 mm. In other embodiments, when the ratio of C_{Dout} to S_{Din} is about 1.30 to 1.0 to about 1.45 to 1.0, the sleeve wall thickness may be in a range from about 0.40 mm to about 0.50 mm. That is, the greater the difference between the outer diameter of the core and the inner diameter of the sleeve, the greater the wall thickness of the sleeve must be in order to enable sufficient stretching of the sleeve over the core without breaking or cracking the material of the sleeve.

### BRIEF DESCRIPTION OF THE DRAWINGS

These and other features and advantages of the present invention will be better understood by reference to the following detailed description when considered in conjunction with the accompanying drawings, in which:

FIG. 1 is a schematic perspective view of the core of a valve according to embodiments of the present invention;

FIG. 2 is a schematic perspective view of a valve including a core and sleeve according to embodiments of the present invention;

FIG. 3 is a schematic perspective view of an encapsulated valve according to embodiments of the present invention;

FIG. 4 is a photograph of a valve according to embodiments of the present invention;

FIG. 5A is a graphical representation of the cracking pressure (i) and sustained open pressure (ii) of a valve according to embodiments of the present invention;

FIG. 5B is a graphical representation of the cracking and sustained open pressures for the two stainless steel valve sets (Examples 1 and 2);

FIG. 5C is a graphical representation of the cracking and sustained open pressures for the Example 3 PEEK valves (sets 1 through 5), as a function of silicone sleeve inner diameter;

FIG. 6 is a graph showing the average cracking pressures and standard deviations of one set of valves at flow-rates of 200 μL/min and 500 μL/min, and of a second sets of valves at a flow rate of 500 μL/min (n=30), according to embodiments of the present invention;

FIG. 7 is a graph depicting the relative fluorescence over time of PEEK valves used in LAMP positive nucleic acid amplification reactions (top-most lines) and LAMP negative nucleic acid amplification reactions (bottom-most lines), in which some PEEK valves were subjected to dry auto-claving (solid lines) and some PEEK valves were in their original form having not been subjected to auto-claving (dotted lines);

FIG. 8A is a photograph of the valves manufactured according to Example 1 (set 1) and Example 2 (set 2); and

FIG. 8B is a photograph of the valves manufactured according to Example 3.

### DETAILED DESCRIPTION

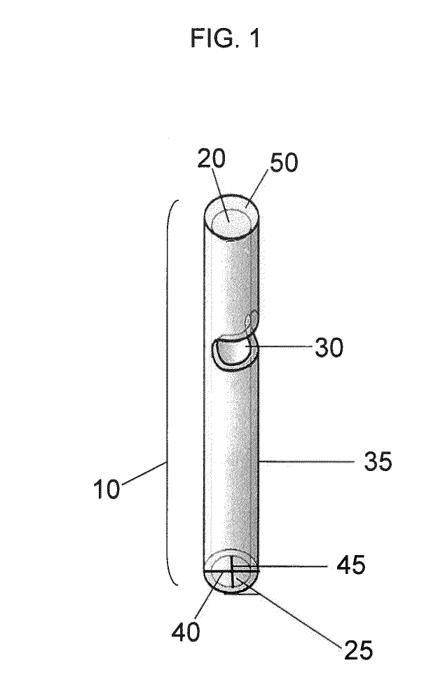

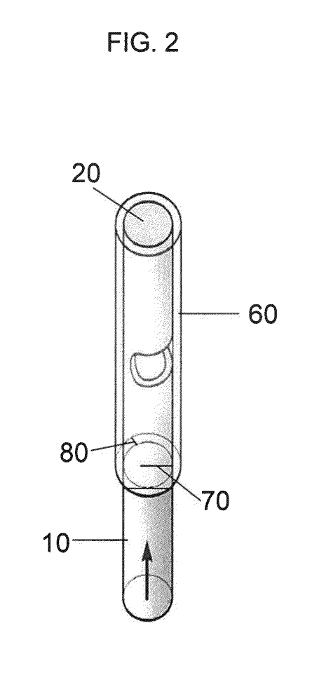

In some embodiments of the present invention, as shown in FIGS. 1 and 2, a valve includes a generally hollow core (10) having one closed end (20) and one open end (25) and at least one side port (30) in a sidewall (35) of the core (10). The valve also includes a sleeve (60) that fits over the core (10). In some embodiments, for example, a valve consists essentially of the core (10) and sleeve (60). In such an embodiment, the core (10) includes a generally hollow elongated member having at least one side port (30) in a sidewall (35) of the generally hollow elongated member. The sleeve (60) is on an outer surface of the core (10) and covers the at least one side port (30) of the core (10). As used herein, the phrase “consists essentially of” and similar phrases, refers to the inclusion of the specified elements and those elements that do not materially alter the function of the listed elements as a valve. However, the phrase “consists essentially of” and similar phrases, refers to the exclusion of additional elements that, if added to the listed elements, would materially alter the function of the elements as a valve.

In some embodiments, the valve may be made using commercially available sub-components or sub-components that can be readily and inexpensively manufactured in large volumes, thereby rendering the valve low-cost and suitable for scale-up manufacturing. In some embodiments, the valves are easy to assemble. In some embodiments, the valve may be manufactured independently from the system into which it is to be inserted. The dead volume within the valve is dependent on the internal geometry and length of the core, and can be reduced without changing the cracking pressure or sleeve material. Since reducing the internal geometry of the core, such as, for example, the internal diameter of a cylindrical core (45), increases the overall flow resistance, the most suitable internal geometry of the core depends on the requirements of a given application.

With reference to FIG. 2, a sleeve (60) is fitted over at least a portion of the core (10) and covers all side ports (30). In use, when sufficient positive pressure is applied to the interior of the core (e.g., from the flow of fluid at a sufficient pressure from the open end of the core (25) toward the closed end of the core (20)), the sleeve expands to allow the fluid to flow out of the core through the side port (30) and then between the exterior of the core and interior of the sleeve. The radially oriented pressure out the side port(s) in conjunction with the friction between the sleeve and the core prevents the sleeve from slipping along the core when the fluid is being released between the interior of the sleeve and the exterior of the core. Once the pressure is reduced, the sleeve returns to its original size, thereby closing the port and preventing backflow.

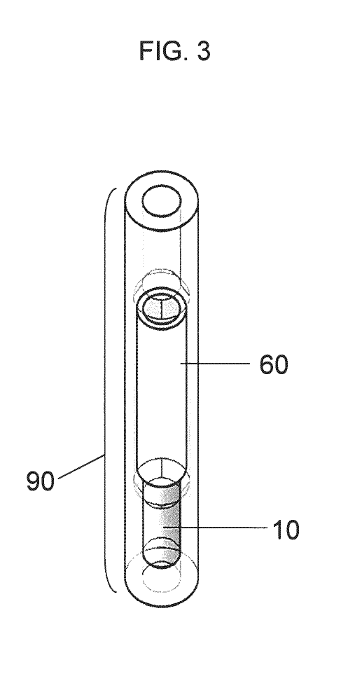

The valve according to embodiments of the present invention may be easily integrated into any system requiring a valve by fitting the open end of the core into the fluid path. The valve can be used in any configuration, such as an open configuration in which the fluid flows out of the valve into a reservoir, or an encapsulated configuration (such as the one shown in FIG. 3) in which the valve is encapsulated in a fluid conduit (90) to create an in-line check valve. Valves having a similar purpose and function have been proposed. However, these proposed valves do not have the same core and/or sleeve geometry as the valves disclosed herein. Because the proposed check valves do not have the same core and sleeve geometry as the present invention, they are not as simple to manufacture, which renders them more complex and costly. Also, these proposed valves do not appear to be commercially available, perhaps due to the cost prohibitive nature of their manufacture.

The core may be made of any suitable material, but the material of the core should be generally rigid in comparison with the material of the sleeve. This difference in rigidity between the sleeve and the core simplifies fitting the sleeve onto the core, and ensures that the sleeve will not slip during valve operation. In addition, for proper operation of the valve, the core must not expand at pressures equal to or smaller than the anticipated operating pressures. Non-limiting examples of suitable materials for the core include metals, including alloys and combinations of different metals (e.g., stainless steel, steel, aluminum and/or copper), plastics and combinations of different plastics (e.g., polypropylene (PP), polyethylene (PE), PC (polycarbonate), PVC (polyvinylchloride), Delrin® (i.e., acetal resins), Teflon® (i.e., polytetrafluoroethylene), acrylic (e.g. polyacrylonitrile), PEEK (polyetheretherketone) and/or polymer blends), and combinations thereof.

The exterior of the core (10) is generally cylindrical at least in the area that functions as the valve, i.e., the area immediately surrounding the side port(s) on the core. The interior of the core (10) may be any shape so long as it remains generally hollow. For example, the inside of the core (10) may have a cross-section that is generally circular, trapezoidal, square or rectangular. However, the present invention is not limited to these shapes. In some embodiments, though, the core is generally cylindrical (i.e., the core inside and outside have a generally circular cross-section). The generally cylindrical shape of the core according to these embodiments minimizes dead volume and simplifies the manufacturing process. The core is also elongated such that fluid entering the open end of the core travels along a length of the core before reaching the side port.

The ends of the core may have a shape different from the area that functions as the valve, i.e., the area immediately surrounding the side port(s) on the core, to facilitate press-fitting or other insertion methods. The interior diameter and interior geometry of the core can be any suitable size, and is generally selected to achieve the desired balance between overall flow resistance and dead volume.

As discussed above, the core may include at least one side port. There may be any number of side ports in the core so long as all side ports are covered by the sleeve. The shape of the side ports is not particularly limited, and may be any suitable geometry, including, but not limited to slits, circular holes, or other hole geometries. Also, when the core includes more than one side port, the side ports may all have the same size and geometry, or may have varying sizes and geometries, depending on the desired properties of the valve. The shape of the side ports may be determined by the fabrication method and what shapes and sizes are most cost effective. The shape of the holes does not affect the cracking pressure of the valve. However, the size of the hole may be determined based on the desired flow resistance or other parameter.

The core may be manufactured by any suitable method. For example, the core may be machined from a solid stock, cut and swaged from existing tubing, or deep drawn and punched.

The deep draw method may be more practical at large volumes because of its low manufacturing cost and inherent ability to produce parts with one closed end.

The sleeve material can be made from any suitable material that is capable of stretching or otherwise fitting over the core and covering the side port(s). For example, in some embodiments, the sleeve may be made of an elastomeric material such as silicone, latex, or a thermoelastic plastic. The simplest method of manufacturing the sleeve is to extrude a length of tubing and then cut the extruded tubing to the desired length. However, any suitable method of manufacturing the sleeve may be used. One additional exemplary method includes molding individual sleeves. Because the materials of the core and sleeve are relatively inexpensive, the entire valve is disposable, making it particular suitable for use in disposable devices, such as, for example, certain medical devices and other systems.

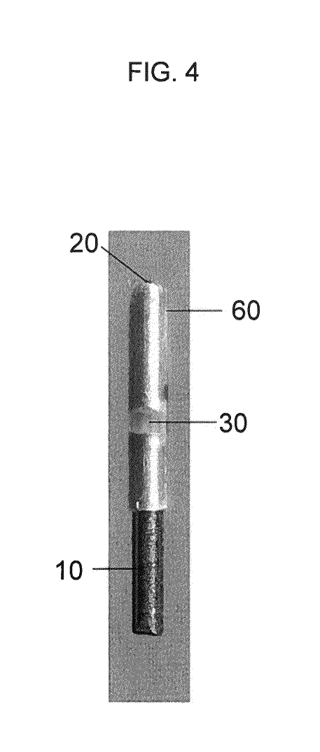

FIG. 4 is a photograph of a valve having a core (10) made from stainless steel hypodermic tubing with one closed end (20), and having one side port (30) and a sleeve (60) made from silicone fitted over the core.

Rigid and elastic tubing of precise diameters are readily available at low costs. Other features of the valve, such as the geometry of the side port, length of the sleeve, or position of the sleeve, are substantially more expensive to manufacture to the same precision. However, the cracking pressure depends primarily on the diameters of the materials and, therefore, the tolerances on other features may be relaxed, if the features are even necessary. With a focus primarily on the diameters of the materials, the manufacturing and assembly is simplified, allowing for large scale manufacturing of valves.

Because the valves according to embodiments of the present invention are simple and easy to manufacture, they are highly customizable. In particular, the cracking pressure of the valve is easily adjustable by adjusting certain geometrical parameters of the valve. The cracking pressure of the valve depends predominantly on the valve core outer diameter, the sleeve inner diameter, the sleeve wall thickness, and the sleeve material's modulus of elasticity. These parameters can be controlled to tight tolerances, while the tolerances on other features can be relaxed, thereby simplifying valve manufacturing and assembly, and enabling customization of the cracking pressure of the valve for different applications. Indeed, according to some embodiments, valves produced from different materials and with varying different parameters (e.g., the valve core outer diameter, the sleeve inner diameter, the sleeve wall thickness, and the sleeve material's modulus of elasticity) can exhibit tunable, distinct and reproducible cracking pressures in the range of about 2 to about 20 psi.

For example, in some embodiments, the valve core (10) has an outer diameter (40) from about 1.0 to about 2.0 mm in size. The sleeve may have an inner diameter (70) from about 0.70 mm to about 1.50 mm, and a sleeve wall thickness (80) from about 0.20 mm to about 0.50 mm. As can be appreciated, however, in order for the sleeve to fit tightly around the core, the inner diameter of the sleeve should be at least slightly smaller than the outer diameter of the core. Also, a ratio of the core outer diameter to the sleeve inner diameter may be about 1.05:1 to about 1.45:1, for example about 1.07:1 to about 1.45:1 or about 1.30:1 to about 1.45:1. In some embodiments, when the ratio of the core outer diameter (C_{Dout}) to the inner diameter of the sleeve (S_{Din}) is about 1.05 to 1.0 to about 1.29 to 1.0, the sleeve wall thickness may be in a range from about 0.20 to about 0.25 mm. In other embodiments, when the ratio of C_{Dout} to S_{DI} is about 1.30 to 1.0 to about 1.45 to 1.0, the sleeve wall thickness may be in a range from about 0.40 mm to about 0.50 mm. That is, the greater the difference between the outer diameter of the core and the inner diameter of the sleeve, the greater the wall thickness of the sleeve must be in order to enable sufficient stretching of the sleeve over the core without breaking or cracking the material of the sleeve.

The cracking pressure of the valves according to embodiments of the present invention does not vary significantly as a function of flow rate. Also, the valves exhibit substantially no back flow leakage within a range of about 30 psi. The valves can have dead volumes that are low. For example, in some embodiments, the dead volume is about 3-4 μL. The valve dead volume depends mainly on the core inner diameter and length, and can be further tailored by adjusting these parameters.

A mathematical model for an idealized case, using elasticity theory of thick-walled cylinders predicts that the cracking pressure of the valve is dependent on the modulus of the sleeve material, the outer diameter of the core, and the inner diameter and wall thickness of the sleeve.

Although this model is based on an idealized case, it is expected that valves can be created with different and tunable cracking pressures by varying the above mentioned core and/or sleeve geometries.

According to the mathematical model, the elastomeric sleeve, when stretched on the core, applies an inward radial pressure. The valve will open when the pressure applied through the interior of the core exceeds the inward pressure applied by the sleeve. This pressure is derived below using elasticity theory of thick walled cylinders.

The hoop stress, σ_{θθ}, at the inner surface of a thick walled cylinder with free ends is represented by Equation 1, below.

$${σ}_{θ θ} = {P}_{i} \frac{{b}^{2} + {a}^{2}}{{b}^{2} - {a}^{2}} - {P}_{o} \frac{2 {b}^{2}}{{b}^{2} - {a}^{2 }} \qquad Equation 1$$

In Equation 1, Pᵢ is the internal pressure, Pₒ is the external pressure, a is the internal radius, and b is the external radius. According to embodiments of the present invention, the elastic sleeve experiences a constant external pressure equivalent to one atmosphere, Pₒ=Pₐₜₘ. The internal radius of the sleeve is forced to the outer radius of the core, a=r_{c}, and the external radius of the sleeve is the sum of its internal radius and the wall thickness t, b=r_{c}+t. Accordingly, Equation 1 can be rewritten as Equation 2, below.

$${σ}_{θ θ} = {P}_{i} \frac{{( {r}_{c } + t )}^{2} + {r}_{c}^{2}}{{( {r}_{c} + t )}^{2} - {r}_{c}^{2}} - {P}_{at m} \frac{2 {( {r}_{c} + t )}^{2}}{{( {r}_{c} + t )}^{2} - {r}_{c}^{2}} \qquad Equation 2$$

It is assumed that in the domain of stretching the sleeve will experience as a valve component, the sleeve is linearly elastic and the wall thickness is not significantly affected. The elastic stress, σ, is proportional to the strain, ε, dependent on the modulus of elasticity, E, as shown in Equation 3, below. Here, the hoop stress is caused by and equivalent to the elastic stress, σ_{θθ}=σ.

$$ɛ = \frac{σ}{E} \qquad Equation 3$$

The circumferential strain on the elastic sleeve at its inner surface is determined by the change in circumference expanded from its inner resting circumference of radius, rₛ, to its new circumference equivalent to the outer radius of the core, r_{c}, normalized by the resting circumference, as shown in Equation 4, below.

$$ɛ = \frac{2 π {r}_{c} - 2 π {r}_{s}}{2 π {r}_{s}} = \frac{{r}_{c}}{{r}_{s}} - 1 \qquad Equation 4$$

Combining Equations 2 and 4, the gauge pressure, P=Pᵢ-Pₐₜₘ, applied by the elastic sleeve on the rigid core is represented by Equation 5, below.

$$P = [ E ( \frac{{r}_{c}}{{r}_{s}} - 1 ) + {P}_{a t m} ] \frac{{( {r}_{c} + t )}^{2} - {r}_{c}^{2}}{{( {r}_{c} + t )}^{2} + {r}_{c}^{2}} \qquad Equation 5$$

The cracking pressure of the valve, defined as the gauge pressure of the sleeve on the core is therefore dependent solely on the modulus of the sleeve material, the outer radius of the core, and the inner radius and wall thickness of the sleeve.

This mathematical model provides a good indication that different and tunable cracking pressures can be achieved by varying the core and/or sleeve geometries. In reality, however, other factors likely also contribute to valve performance, such as small adhesive forces and/or friction between the core outer surface and the inner surface of the sleeve, and axial deformation of the sleeve. Such additional forces likely contribute to the two distinct observable pressures associated with the opening of the valve. First, there is an initial pressure spike indicating the true cracking pressure, where the pressure inside the valve core is large enough to stretch the sleeve open. This initial spike is referred to as the valve cracking pressure. After this initial pressure spike, there is a lower pressure associated with maintaining the valve in the open position. This pressure is referred to as the sustained open pressure.

The following examples are presented for illustrative purposes only, and do not limit the scope of the invention.

### EXAMPLES

### Example 1

A core of a valve was made from stainless steel hypodermic tubing (Small Parts, Inc) with an outer diameter (40) of 0.065±0.0005 inches (1.7±0.01 mm), and an inner diameter (45) of 0.055±0.0005 inches (1.4±0.01 mm). The core tubing was sliced into short sections using a cutting wheel on a rotary tool. A notch was then cut on the side into each segment to create the side port. One end of each segment was sealed with UV curing glue (KOA 300, Kemxert Corporation) or, alternatively, with melted polycarbonate to create a closed end of the core.

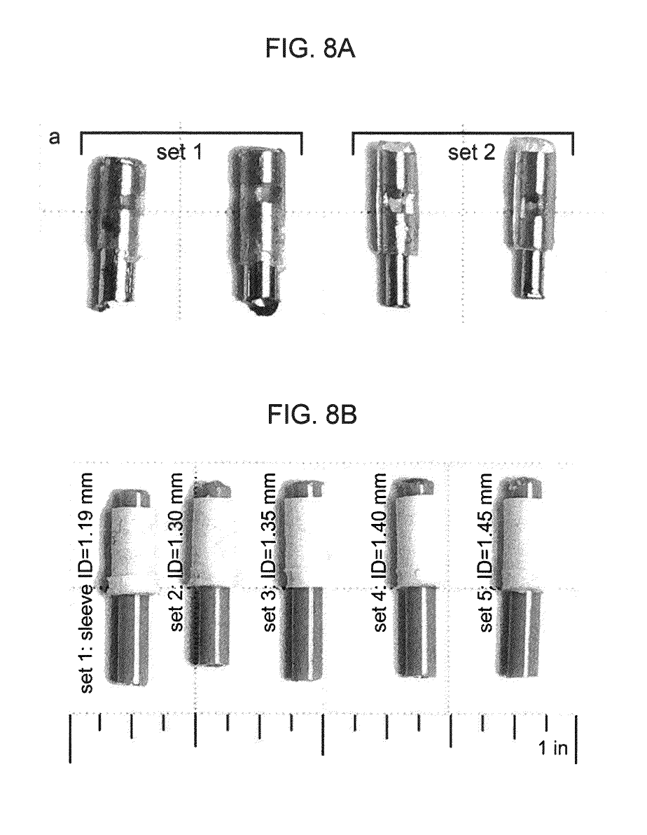

The valve sleeve was made from silicone tubing, with an inner diameter (80) of 0.058 inches (1.47 mm) and a wall thickness (80) when relaxed (VWR International, LLC) of 0.009 inches (0.229 mm). The axial modulus of elasticity of the sleeve material was determined experimentally by performing a tensile test (Instron®), and was found to be 482±37 psi. The silicone tubing was pushed over the core, covering the side port. A puff of air was injected into the sleeve to inflate the tubing above the cracking pressure. This relieved any axial stretch that may have occurred while putting the sleeve on the core. Excess silicone was cut away with scissors. Photographs of the valves manufactured according to this Example are shown in FIG. 8A (indicated as set 1).

### Example 2

An analogous set of valves (analogous to the Example 1 valves) was fabricated using the same method as in Example 1, but with alternate dimensions for the core and sleeve. The alternate set of valves had a core with an outer diameter (40) of 0.0420±0.0005 inch (1.07±0.01 mm), an inner diameter (45) of 0.027±0.0005 inch (0.69±0.01 mm), and a sleeve with an inner diameter of 0.030 inch and a wall thickness of 0.018 inch. The axial modulus of elasticity of the sleeve material was determined experimentally by performing a tensile test (Instron®), and was found to be 229±19 psi. Photographs of the valves manufactured according to this Example are shown in FIG. 8A (indicated as set 2).

### Example 3

Several valves were made using a core made from PEEK (polyetheretherketone) tubing (Zeus, Inc), sliced into short segments with a razor blade. A notch was then cut in the side of each segment to create the side port. One end of each segment was sealed by melting the PEEK material.

The valve sleeve was made by casting silicone (R1328, Silpak, Inc.) into short cylinders with varying inner diameters and wall thickness. These sleeves were then pushed over the PEEK core, covering the side port. As in Examples 1 and 2, a puff of air was injected into the valve to relive any axial deformation of the sleeve. Several valves were manufactured in this manner with constant core dimensions and sleeve wall thicknesses. Photographs of the valves manufactured according to this Example are shown in FIG. 8B, which also indicates the sleeve inner diameters (i.e., 1.19 mm, 1.30 mm, 1.35 mm, 1.40 mm and 1.45 mm).

The various dimensions and parameters of the valves prepared according to Examples 1-3 are summarized in Table 1, below.

TABLE 1

| | Steel Valves | Steel Valves | PEEK Valves |
|---|---|---|---|
| | Example 1 | Example 2 | Example 3 |
| Core Outer | 0.065 ± 0.0005″ | 0.042 ± 0.0005″ | 0.061 ± 0.0003″ |
| Diameter | (1.65 ± 0.01 mm) | (1.07 ± 0.01 mm) | (1.56 ± 0.007 mm)^{c} |
| Core Inner | 0.047 ± 0.0005″ | 0.027 ± 0.0005″ | 0.03 ± 0.002″ |
| Diameter | (1.19 ± 0.01 mm) | (0.69 ± 0.01 mm) | (0.76 ± 0.05 mm) |
| Sleeve Inner | 0.058″ (1.47 mm) | 0.030″ (0.76 mm) | 0.047-0.057″ |
| Diameter ^{a} | | | (1.19-1.45 mm)^{d} |
| Sleeve Wall | 0.009″ (0.229 mm) | 0.018″ (0.46 mm) | 0.017″ (0.43 mm) |
| Thickness ^{a} | | | |
| Sleeve axial | 482 ± 37 PSI | 229 ± 19 PSI | 79.0 ± 0.1 PSI |
| modulus of elasticity^{b} | | | |

^{a} Sleeve inner diameter and wall thickness when sleeve is relaxed.
^{b}Determined experimentally by performing a tensile test (Instron ®) with 10 replicates for each sleeve material.
^{c}Measured for actual PEEK tubing batch used in valve construction.
^{d}Multiple valve sets were fabricated with different sleeve inner diameters, see FIG. 8B.

### Performance Evaluation

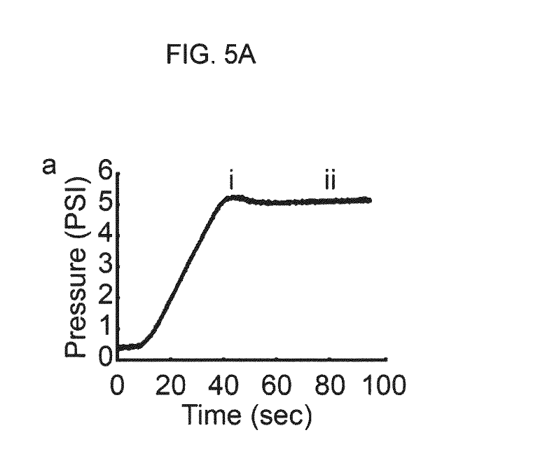

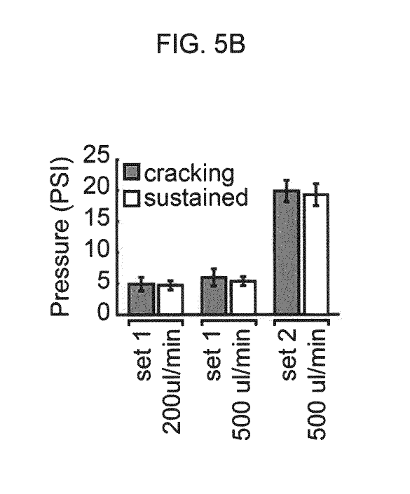

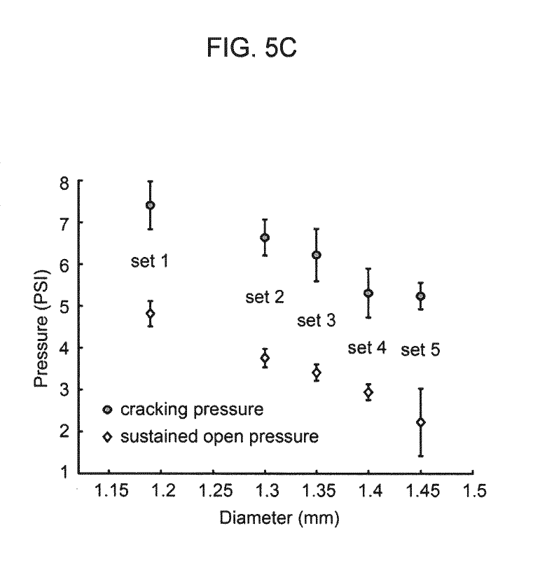

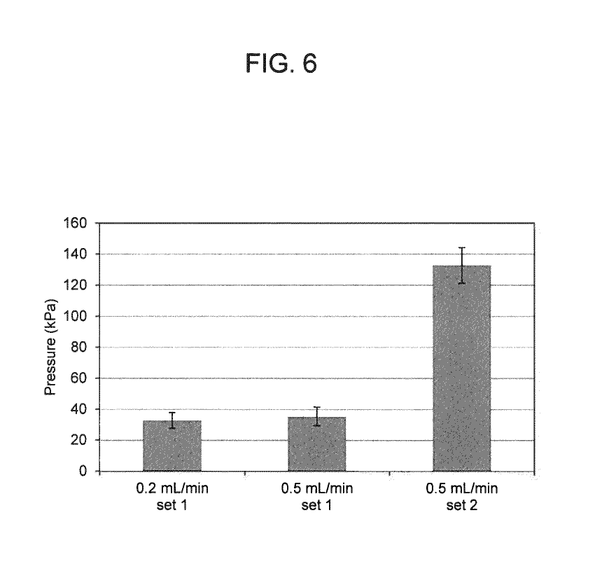

Each of the valves was tested by connecting them at the inlet to a syringe pump and a fluid filled pressure sensor (Omega Engineering, Inc) via a T-junction. At the outlet, each valve was open to the atmosphere such that the gauge pressure measured by the sensor represented the pressure drop across the valve. This pressure was recorded over time while activating each valve. The cracking pressure and the sustained open pressure were determined, and the results are shown in Table 2, below. As shown graphically in FIG. 5A, with the syringe pump set to a fixed flow rate, the pressure upstream of the valves increased until it reached the cracking pressure (i). Thereafter, the pressure held steady at the sustained open pressure (ii). FIG. 5B is a graphical representation of the cracking and sustained open pressures for the two stainless steel valve sets (Examples 1 and 2). FIG. 5C is a graphical representation of the cracking and sustained open pressures for the Example 3 PEEK valves (sets 1 through 5), as a function of silicone sleeve inner diameter.

TABLE 2

| | | | Sustained Open |
|---|---|---|---|
| | Flow rate | Cracking Pressure | Pressure |
| Valve Type ^{a} | [μL/min] | [PSI] | [PSI] |
| Example 1 | 500 | 6.00 ± 1.38 | 5.39 ± 0.71 |
| Example 1 | 200 | 4.93 ± 1.09 | 4.74 ± 0.75 |
| Example 2 | 500 | 19.89 ± 1.73 | 19.29 ± 1.77 |
| Example 3 set 1 | 500 | 7.41 ± 0.57 | 4.82 ± 0.30 |
| Example 3 set 2 | 500 | 6.64 ± 0.43 | 3.76 ± 0.22 |
| Example 3 set 3 | 500 | 6.22 ± 0.63 | 3.41 ± 0.20 |
| Example 3 set 4 | 500 | 5.31 ± 0.58 | 2.94 ± 0.19 |
| Example 3 set 5 | 500 | 5.24 ± 0.32 | 2.22 ± 0.80 |
| Example 3 set 6^{b} | 500 | 7.81 ± 0.53 | 6.23 ± 0.50 |
| Example 3 set 6^{b} | 200 | 7.83 ± 0.52 | 6.08 ± 0.71 |
| Example 3 set 6^{b} | 100 | 7.00 ± 0.57 | 5.34 ± 0.83 |

^{a} Five to ten identically manufactured valves tested per data set.
^{b}PEEK (Example 3) set 6 manufactured using sleeves with inner diameter nominally identical to PEEK (Example 3) set 1, but manufactured using a different mold with slight differences in other parameters.

All valves tested provided distinct and reproducible cracking and sustained open pressures (as shown in Table 2, and FIGS. 5A, 5B and 5C), with pressure values ranging from 2 to 20 PSI, depending on the valve type. This ability to tune the cracking and sustained open pressures enables ready fabrication of valves suitable for different applications. No back flow leakage was encountered prior to exceeding the measurement capabilities of the pressure sensor (30 PSI). Furthermore, the observed trends in cracking pressure agree qualitatively with the trends predicted by the mathematical model discussed above. The steel valves of Example 2 had significantly larger cracking and sustained open pressure values compared to the steel valves of Example 1, as expected based on the larger difference between the core outer and sleeve inner diameters, and the larger sleeve wall thickness for the Example 2 valves. For the PEEK core valves, as predicted by the model, the cracking and sustained open pressure decreased as the inner diameter of the sleeve increased (FIG. 5C). Furthermore, upon decreasing the flow rate from 500 to 200, and 100 pt/min, the cracking and sustained open pressures for representative steel and PEEK valve sets decreased slightly, by up to approximately 1 PSI (Table 2).

The cracking versus sustained open pressure was not significantly different for the steel valves (p value≧0.499), but for the PEEK valves, the cracking pressure was 2.0±0.8 PSI larger than the sustained open pressure (p value≧0.00012). It is hypothesized that the difference between cracking and sustained open pressure depends primarily on the materials used for the sleeve and core, which dictate the adhesion and friction between the sleeve and core. The cast silicone sleeves appear to have much stronger adhesive interactions with different surfaces, compared to the sleeves obtained from silicone tubing. If having a cracking pressure spike is undesirable for a particular application, this can be remedied by choosing different sleeve and/or core materials.

The dead volume within the valve depends on the internal geometry and length of the core. The stainless steel core valves had a dead volume of 15 μL for Example 1, and 3 μL for Example 2. The dead volume of the PEEK core valves (Example 3) was 4 μL. The volume can be reduced without changing the cracking pressure or sleeve material by increasing the wall thickness of the core, thereby reducing the internal diameter and dead volume. However, reducing the internal diameter of the core increases the overall flow resistance. Therefore, the most suitable core inner diameter will be selected based on the requirements of a given application.

The valves according to embodiments of the present invention are suitable for use in the disposable cartridge for isothermal nucleic acid amplification described in U.S. Provisional Application No. 61/622,005, filed Apr. 10, 2012 and titled SYSTEM AND METHOD FOR EFFICIENT NUCLEIC ACID TESTING, U.S. Provisional Application Ser. No. 61/799,776, filed Mar. 15, 2013 and titled SYSTEM CARTRIDGE FOR EFFICIENT NUCLEIC ACID TESTING, and the co-pending non-provisional U.S. patent application titled SYSTEM AND CARTRIDGE FOR EFFICIENT NUCLEIC ACID TESTING filed on Apr. 10, 2012 claiming priority to the 61/622,005 and 61/799,776 provisional applications, the entire contents of all of which are incorporated herein by reference. However, the valves may also be used in any fluidic system that executes nucleic amplification. In such fluidic systems that execute nucleic acid amplification, components that come in contact with sample or master-mix fluids should be free of the target DNA or RNA, or products of target amplification, to prevent false positive amplification. In the cartridge described in U.S. Provisional Application No. 61/622,005, DNA contamination can be eliminated by subjecting cartridge components to a dry-autoclave cycle for 50 minutes at 120° C. To evaluate the effect of autoclaving on the cracking pressure of the valves according to embodiments of the present invention, 8 fully-assembled PEEK core valves were dry-autoclaved, and their valve cracking pressures before and after autoclaving were determined. As discussed and shown below, autoclaving decreased the valve cracking pressure by less than 1 PSI, within the error bars of the experiment, and did not seem to adversely affect their performance. Furthermore, the valves come in contact with the master-mix prior to isothermal Loop Mediated Amplification (LAMP). None of the valve materials inhibited the LAMP reactions, and autoclaving did not affect the amplification results. Further, in LAMP-based DNA amplification in the cartridge configuration (disclosed in U.S. Provisional Application No. 61/622,005) including the valves, the valves functioned in this system as expected.

In particular, to evaluate the effect of autoclaving on the cracking pressure of the valves, four PEEK valves before autoclaving and four PEEK valves after autoclaving were tested at a flow rate of 200 μL/min. The valves tested after autoclaving were dry autoclaved for 50 minutes at 121° C. prior to the experiment. The cracking pressure results are shown in Table 2 below. As can be seen in Table 3, the valve cracking pressure decreases slightly after autoclaving, but the difference is not statistically significant (i.e., p≧0.13).

TABLE 3

| | | Flow rate | Cracking Pressure |
|---|---|---|---|
| Valve Type | Autoclaved | [μL min] | [PSI] |
| PEEK set 1 | No | 200 | 6.26 ± 0.83 |
| PEEK set 1 | Yes | 200 | 5.56 ± 0.36 |
| PEEK set 4 | No | 200 | 4.15 ± 0.45 |
| PEEK set 4 | Yes | 200 | 3.69 ± 0.09 |

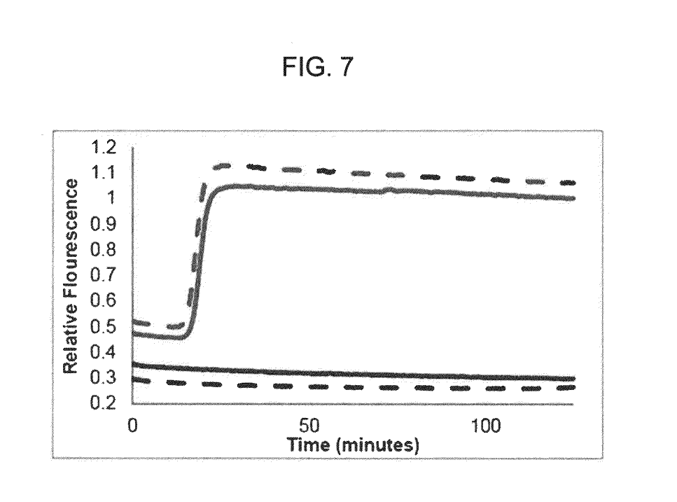

To evaluate whether autoclaving of the valve inhibits nucleic acid amplification reactions, autoclaved valve materials and non-autoclaved valve materials were incubated in the reaction buffer prior to running the amplification reactions. In particular, a small piece of each valve material, either autoclaved or in its original form, was incubated in LAMP reaction buffer for 60 minutes at 63° C. with agitation. The buffer solution was then used in setting up LAMP reactions that were subsequently amplified in the present and absence of the targeted genomic DNA by incubation at 63° C., with real time fluorescence monitoring using an Opticon2 real-time PCT instructions (from Bio-Rad Laboratories, Inc. in Hercules, Calif.). The results of this testing is shown in FIG. 7, which is a graph of relative fluorescence over time. In FIG. 7, the top-most lines (one solid and one dotted) reflect the LAMP positive reactions containing 3000 copies of target genomic DNA per reaction, and the bottom-most lines (one solid and one dotted) reflect the LAMP negative control reactions, which did not contain target DNA. The solid lines in FIG. 7 correspond to the reactions exposed to autoclaved valve materials, and the dotted lines correspond to control reactions that were not exposed to any valve materials. As can be seen from FIG. 7, the autoclaved valve materials do not inhibit the reactions.

As shown in FIGS. 1 and 2 and discussed throughout, stand-alone, miniature check valves are disclosed having selectable and reproducible cracking and sustained open pressures. The axial flow alignment of the valve lends itself to be press-fit, or similarly inserted into a flow path. The valves can be fabricated in a simple and reproducible manner from readily available, low-cost materials. Some embodiments of the production process involve manual cutting, sealing, and notching of the rigid core, but production can alternatively be accomplished through industry-standard deep draw production methods. Likewise, casting can be used to generate elastomeric sleeves of varying inner diameters, but for mass production, the sleeves can be more readily obtained in large volume by injection molding, or by cutting silicone tubing of the appropriate inner diameter and wall thickness into shorter pieces. Therefore, the production of these valves can be scaled up to large-volumes using traditional manufacturing techniques. The valves can be manufactured from non-reactive materials that are compatible with challenging applications such as medical devices and systems used for the automation of biological assays. Additionally, in contrast to lithography-based microvalves that generally must be manufactured in situ within a fluidic device, the valves according to embodiments of the present invention can be manufactured independently of, and be readily integrated into, fluidic systems manufactured by a wide range of fabrication methods.

While certain exemplary embodiments of the present invention have been illustrated and described, those of ordinary skill in the art will understand that various changes and modifications may be made to the described embodiments without departing from the spirit and scope of the present invention, as defined in the following claims.

What is claimed is:

1. A valve, comprising:
a core comprising a generally hollow elongated member having at least one side port in a sidewall of the generally hollow elongated member; and
a sleeve on an outer surface of the core and covering the at least one side port.

2. The valve according to claim 1, wherein the core is generally cylindrical.

3. The valve according to claim 1, wherein a portion of the sleeve covering the sideport has an inner diameter in a relaxed state that is smaller than an outer diameter of the core.

4. The valve according to claim 1, wherein a ratio of an outer diameter of the core to an inner diameter of the sleeve is about 1.07:1 to about 1.29:1.

5. The valve according to claim 1, wherein the sleeve has a wall thickness of about 0.20 to about 0.50 mm.

6. The valve according to claim 1, wherein a ratio of an outer diameter of the core to an inner diameter of the sleeve is about 1.14:1 to about 1.17:1.

7. The valve according to claim 6, wherein the sleeve has a wall thickness of about 0.20 to about 0.25 mm.

8. The valve according to claim 1, wherein a ratio of an outer diameter of the core to an inner diameter of the sleeve is about 1.30:1 to about 1.45:1.

9. The valve according to claim 8, wherein the sleeve has a wall thickness of about 0.40 mm to about 0.50 mm.

10. The valve according to claim 1, wherein the core comprises a material selected from the group consisting of metals and plastics.

11. The valve according to claim 1, wherein the core comprises a material selected from the group consisting of:
stainless steel, steel, aluminum, copper, alloys thereof, combinations thereof; and
polypropylene, polyethylene, polycarbonate, polyvinylchloride, acetal resins, polytetrafluoroethylene, acrylics, polyacrylonitrile, polyetheretherketone, polymers, combinations thereof.

12. The valve according to claim 1, wherein the core comprises stainless steel or polyetheretherketone.

13. The valve according to claim 1, wherein the sleeve comprises an elastomeric material.

14. The valve according to claim 1, wherein the sleeve comprises a material selected from the group consisting of silicone, latex, thermoelastic plastics, and combinations thereof.

15. The valve according to claim 1, wherein the sleeve comprises silicone.

16. A valve, consisting essentially of:
a core comprising a generally hollow elongated member having at least one side port in a sidewall of the generally hollow elongated member; and
a sleeve on an outer surface of the core and covering the at least one side port.

17. The valve according to claim 16, wherein the core is generally cylindrical.

18. The valve according to claim 16, wherein a portion of the sleeve covering the sideport has an inner diameter in a relaxed state that is smaller than an outer diameter of the core.

19. The valve according to claim 16, wherein the core comprises a material selected from the group consisting of:
stainless steel, steel, aluminum, copper, alloys thereof, combinations thereof; and
polypropylene, polyethylene, polycarbonate, polyvinylchloride, acetal resins, polytetrafluoroethylene, acrylics, polyacrylonitrile, polyetheretherketone, polymers, combinations thereof.

20. The valve according to claim 16, wherein the sleeve comprises a material selected from the group consisting of silicone, latex, thermoelastic plastics, and combinations thereof.
